(19) United States
(12) Patent Application Publication
(10) Pub. No.: US 2023/0422173 A1
(43) Pub. Date: Dec. 28, 2023

(54) FLEXIBLE RESTRICTED TARGET WAKE TIME OPERATION

(71) Applicant: Samsung Electronics Co., Ltd., Suwon-si (KR)

(72) Inventors: Rubayet Shafin, Allen, TX (US); Boon Loong Ng, Plano, TX (US)

(21) Appl. No.: 18/339,916

(22) Filed: Jun. 22, 2023

Related U.S. Application Data
(60) Provisional application No. 63/355,422, filed on Jun. 24, 2022.
(60) Provisional application No. 63/399,907, filed on Aug. 22, 2022.

(51) Int. Cl. H04W 52/02; H04W 76/15

(52) U.S. Cl. CPC H04W 52/0248; H04W 76/15; H04W 52/0258

(57) ABSTRACT

Methods and apparatuses for facilitating TWT operation between devices in a wireless local area network. A non-access point (AP) multi-link device (MLD) comprises a processor and stations (STAs), each comprising a transceiver configured to form links with APs affiliated with an AP MLD. A first of the transceivers is further configured to transmit to or receive from the AP MLD over a first of the links a multi-link operation (MLO)-supporting target wake time (TWT) Information frame that includes an indication to suspend or resume TWT service periods (SPs) on a second of the links. The processor is operably coupled to the transceivers and configured to, based on the TWT Information frame being transmitted or received successfully over the first link, suspend or resume the TWT SPs on the second link.

### CROSS-REFERENCE TO RELATED APPLICATION AND CLAIM OF PRIORITY

This application claims priority under 35 U.S.C. § 119(e) to U.S. Provisional Patent Application No. 63/355,422 filed on Jun. 24, 2022, and to U.S. Provisional Patent Application No. 63/399,907 filed on Aug. 22, 2022, which are hereby incorporated by reference in their entirety.

### TECHNICAL FIELD

This disclosure relates generally to power management in wireless communications systems that include multi-link devices. Embodiments of this disclosure relate to methods and apparatuses for enhancing Target Wake Time operations in a wireless local area network communications system.

### BACKGROUND

Wireless local area network (WLAN) technology allows devices to access the internet in the 2.4 GHz, 5 GHz, 6 GHz, or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

Next generation extremely high throughput (EHT) WI-FI systems, e.g., IEEE 802.11be, support multiple bands of operation, called links, over which an access point (AP) and a non-AP device can communicate with each other. Thus, both the AP and non-AP device may be capable of communicating on different bands/links, which is referred to as multi-link operation (MLO). The WI-FI devices that support MLO are referred to as multi-link devices (MLDs). With MLO, it is possible for a non-access point (non-AP) MLD to discover, authenticate, associate, and set up multiple links with an AP MLD. Channel access and frame exchange is possible on each link that is set up between the AP MLD and non-AP MLD. The component of an MLD that is responsible for transmission and reception on one link is referred to as a station (STA).

Target wake time (TWT) is one of the most important features for power management in WI-FI networks, which was developed by IEEE 802.11ah and later adopted and modified into IEEE 802.11ax. With TWT operation, it suffices for a STA to only wake up at a pre-scheduled time negotiated with another STA or AP in the network. In IEEE 802.1 lax standards, two types of TWT operation are possible—individual TWT operation and broadcast TWT operation. Individual TWT agreements can be established between two STAs or between a STA and an AP. On the other hand, with broadcast TWT operation, an AP can set up a shared TWT session for a group of STAs.

Restricted TWT (rTWT or r-TWT) operation is a newly introduced feature in IEEE 802.11be (WI-FI 7), which provides more protection for restricted TWT scheduled STAs in order to serve latency-sensitive applications in a timely manner. Restricted TWT is based on Broadcast TWT mechanisms, however, there are some key characteristics that make restricted TWT operation an important feature for supporting low-latency applications in next generation WLAN systems. Restricted TWT offers a protected service period for its member STAs by sending Quiet elements to other STAs in the basic service set (BSS) which are not members of the rTWT schedule, where the Quiet interval corresponding to the Quiet element overlaps with the initial portion of the restricted TWT service period (SP). Hence, it gives more channel access opportunities to the rTWT member scheduled STAs, which helps latency-sensitive traffic flows.

### SUMMARY

Embodiments of the present disclosure provide methods and apparatuses for facilitating improved TWT operation between devices in a WLAN.

In one embodiment, a non-AP MLD is provided, comprising STAs and a processor operably coupled to the STAs. The STAs each comprise a transceiver configured to form links with APs, respectively, affiliated with an AP MLD. A first of the transceivers is further configured to transmit to or receive from the AP MLD over a first of the links a multi-link operation (MLO)-supporting TWT Information frame that includes an indication to suspend or resume TWT SPs on a second of the links. The processor is operably coupled to the transceivers and configured to, based on the TWT Information frame being transmitted or received successfully over the first link, suspend or resume the TWT SPs on the second link.

In another embodiment, an AP MLD is provided, comprising APs and a processor operably coupled to the APs. The APs comprise transceivers configured to form links with STAs, respectively, affiliated with a non-AP MLD. A first of the transceivers is further configured to transmit to or receive from the non-AP MLD over a first of the links a multi-link operation (MLO)-supporting TWT Information frame that includes an indication to suspend or resume TWT SPs on a second of the links. The processor is operably coupled to the transceivers and configured to, based on the TWT Information frame being transmitted or received successfully over the first link, suspend or resume the TWT SPs on the second link.

In another embodiment, a method of wireless communication performed by a non-AP MLD that comprises STAs is provided. The method comprises the steps of transmitting to or receiving from an AP MLD, over a first one of links formed between the STAs and APs affiliated with the AP MLD, an MLO-supporting TWT Information frame that includes an indication to suspend or resume TWT SPs on a second of the links, and based on the TWT Information frame being transmitted or received successfully over the first link, suspending or resuming the TWT SPs on the second link.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As used herein, such terms as “1st” and “2nd,” or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIG. 2A illustrates an example AP according to various embodiments of the present disclosure;

FIG. 2B illustrates an example STA according to various embodiments of this disclosure;

FIG. 3 illustrates an example of different timing components pertaining to a TWT SP according to embodiments of the present disclosure;

FIG. 4 illustrates an example format of the TWT Information field in the TWT Information frame of Table 1 according to embodiments of the present disclosure;

FIG. 5 illustrates an example of broadcast TWT schedule suspension for a particular broadcast TWT schedule according to embodiments of the present disclosure;

FIG. 6 illustrates an example of broadcast TWT schedule suspension for a particular broadcast TWT schedule while other broadcast TWT schedules are maintained according to embodiments of the present disclosure;

FIG. 7 illustrates an example format of an EHT Variant TWT Information field including a Broadcast TWT ID subfield according to embodiments of the present disclosure;

FIG. 8 illustrates an example format of an EHT Variant TWT Information field including a Negotiation Type subfield according to embodiments of the present disclosure;

FIG. 9 illustrates an example format of a Broadcast TWT Information field according to embodiments of the present disclosure;

FIG. 10 illustrates an example format of an EHT Variant TWT information field including a Restricted TWT Excluded subfield according to embodiments of the present disclosure;

FIG. 11 illustrates an example format of an EHT Variant TWT Information field including an All Restricted TWT subfield according to embodiments of the present disclosure;

FIG. 12 illustrates an example format of an EHT Variant TWT Information field including an All Restricted TWT subfield when Negotiation Type subfield is set to 0 and All TWT subfield is set to 0 according to embodiments of the present disclosure;

FIG. 13 illustrates an example format of an EHT Variant TWT Information field including an All Restricted TWT subfield when Negotiation Type subfield is set to 0 and All TWT subfield is set to 0 according to embodiments of the present disclosure;

FIG. 14 illustrates an example format of an EHT Variant TWT Information field including an All Restricted TWT subfield according to embodiments of the present disclosure:

FIG. 15 illustrates an example format of an EHT Variant TWT Information field enabling selective exclusion of restricted TWT schedules using an rTWT Schedule Exclusion Information subfield according to embodiments of the present disclosure;

FIG. 16 illustrates an example format of a Generalized TWT Information field of the Generalized TWT Information frame of Table 6 according to embodiments of the present disclosure;

FIG. 17 illustrates an example format of a TWT Information Set subfield according to embodiments of the present disclosure;

FIG. 18 illustrates an example format of a Generalized Restricted TWT Information field of the Generalized Restricted TWT Information frame of Table 7 according to embodiments of the present disclosure;

FIG. 19 illustrates an example format of a Restricted TWT Suspension Information field of the Restricted TWT Suspension Information frame of Table 8 according to embodiments of the present disclosure;

FIG. 20 illustrates a flow chart of an example behavior of an AP in the context of the usage of the Restricted TWT Suspension Information frame according to embodiments of the present disclosure;

FIG. 21 illustrates a flow chart of an example behavior of a non-AP STA in the context of the usage of the Restricted TWT Suspension Information frame according to embodiments of the present disclosure;

FIG. 22 illustrates an example format of a Generalized Restricted TWT Suspension Information field of the Generalized Restricted TWT Suspension Information frame of Table 10 according to embodiments of the present disclosure;

FIG. 23 illustrates an example format of an MLO-Supporting TWT Information field of the MLO-Supporting TWT Information frame of Table 11 according to embodiments of the present disclosure; and

FIG. 24 illustrates an example process for facilitating TWT operation between MLDs using an MLO-Supporting TWT Information frame according to various embodiments of the present disclosure.

### DETAILED DESCRIPTION

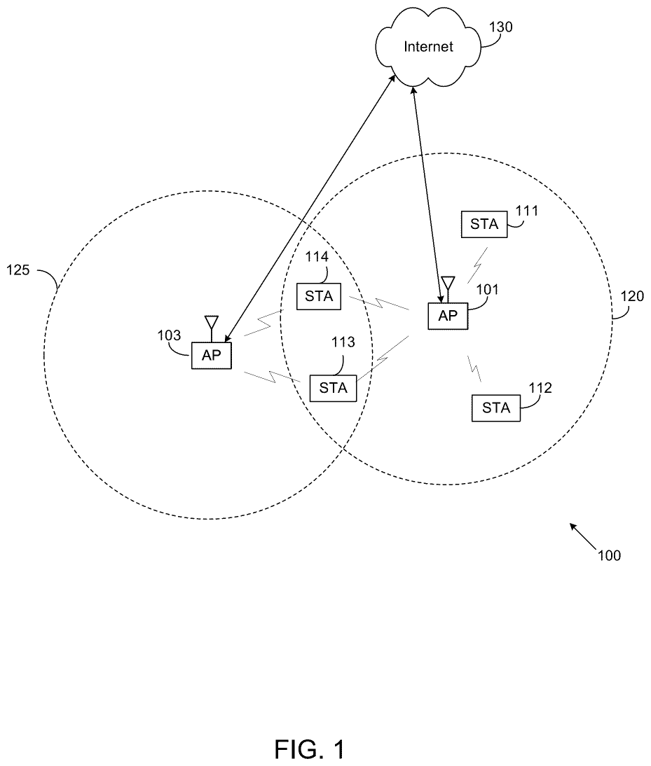

FIGS. 1 through 24, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Embodiments of the present disclosure recognize that for individual TWT, there are mechanisms to suspend or resume a particular individual TWT agreement followed by a TWT requesting STA while maintaining the other TWT agreements, and to suspend or resume all individual TWT agreements followed by the TWT requesting STA. For broadcast TWT, there is a mechanism to suspend or resume all broadcast TWT schedules followed by a TWT scheduled STA. Additionally, embodiments of the present disclosure recognize that Flexible TWT is a TWT the value of which may or may not be selected from the available set of TWT values as per a TWT negotiation. A flexible TWT value can be any positive value regardless of the set of values negotiated for TWTs.

Embodiments of the present disclosure further recognize that according to the current 802.11 specification, while a TWT Information frame can be used for suspending and resuming all the broadcast TWT schedules followed by a broadcast TWT scheduled STA, the TWT Information frame cannot be used for suspending or resuming broadcast TWT SPs on a per-schedule basis. That is, if a broadcast TWT scheduled STA is a member of multiple broadcast TWT schedules, currently it is not possible to suspend a particular broadcast TWT schedule while maintaining the others. Additionally, in 802.11be, with the introduction of the restricted TWT schedule (which is a variant of the broadcast TWT schedule), it would be useful to better manage the broadcast TWT schedules or restricted TWT schedules. Hence, a mechanism to suspend and resume particular broadcast or restricted TWT schedules while maintaining the others would be useful.

Accordingly, embodiments of the disclosure provide mechanisms for selectively suspending particular broadcast TWT schedules or restricted TWT schedules that a STA is a member of while maintaining others.

Embodiments of the present disclosure further recognize that currently, when the All TWT subfield is set to 1 in the TWT Information field in a TWT Information frame, all individual TWT agreements or broadcast TWT schedules are indicated by the TWT Information field of the TWT Information frame as being intended to be suspended or resumed. That is, currently all individual TWT agreements or broadcast TWT schedules are meant to be suspended or resumed by the TWT Information frame—there is no way to selectively exclude any particular individual TWT agreements or broadcast TWT schedules from the group of schedules or agreements that are being suspended or resumed. This is not very conducive for restricted TWT operation, as an r-TWT scheduled STA can have multiple broadcast TWT schedules and restricted TWT schedules, and for some purpose (e.g., power saving), the scheduled STA may want to suspend the broadcast TWT schedules, but may still want to maintain the r-TWT schedules for the purposes of low latency traffic.

Accordingly, embodiments of the disclosure provide mechanisms for selectively excluding TWT agreements or schedules from all TWT suspension.

Embodiments of the present disclosure further recognize that currently the feature of Flexible TWT is not available for broadcast TWT operations. For broadcast TWT, the Next TWT subfield value can only be a value from the available set of values negotiated for TWTs. Accordingly, a broadcast TWT scheduling AP or a broadcast TWT scheduled STA cannot set an arbitrary value in Next TWT, even though this is allowed for individual TWT operations. For r-TWT operation, it would be beneficial for the r-TWT scheduled STA to have the flexibility to set the Next TWT value as needed to any positive value, not necessarily one from the available set of TWT values. This would help any change in the traffic pattern without negotiating a new r-TWT schedule with the r-TWT scheduling AP.

Accordingly, embodiments of the disclosure provide mechanisms for Flexible TWT value selection with broadcast TWT schedules and restricted TWT schedules.

Embodiments of the present disclosure further recognize that currently the TWT Information frame is a unicast frame. It can't be transmitted to multiple STAs at the same time. An r-TWT scheduling AP can be affiliated with an AP MLD, and for various reasons (e.g., power saving), the AP may want to disable the associated link for certain time period. Currently there is no way to use TWT Information frame to notify all or multiple STAs in the BSS about this event.

Accordingly, embodiments of the disclosure provide mechanisms for an AP affiliated with an Ap MLD to notify multiple STAs in the BSS that the AP is temporarily disabling a link.

Embodiments of the present disclosure further recognize that currently the TWT Information frame cannot operate on an MLD level. An MLD may want to suspend individual TWT agreements or broadcast TWT schedules on multiple links to save power. It would be beneficial to have a mechanism to indicate for which link among the multiple links between the AP MLD and the non-AP MLD the TWT Information frame is intended.

Accordingly, embodiments of the disclosure provide mechanisms for an MLD to indicate which link a particular TWT Information frame is intended for.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of STAs 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating improved TWT operation between devices in WLANs. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

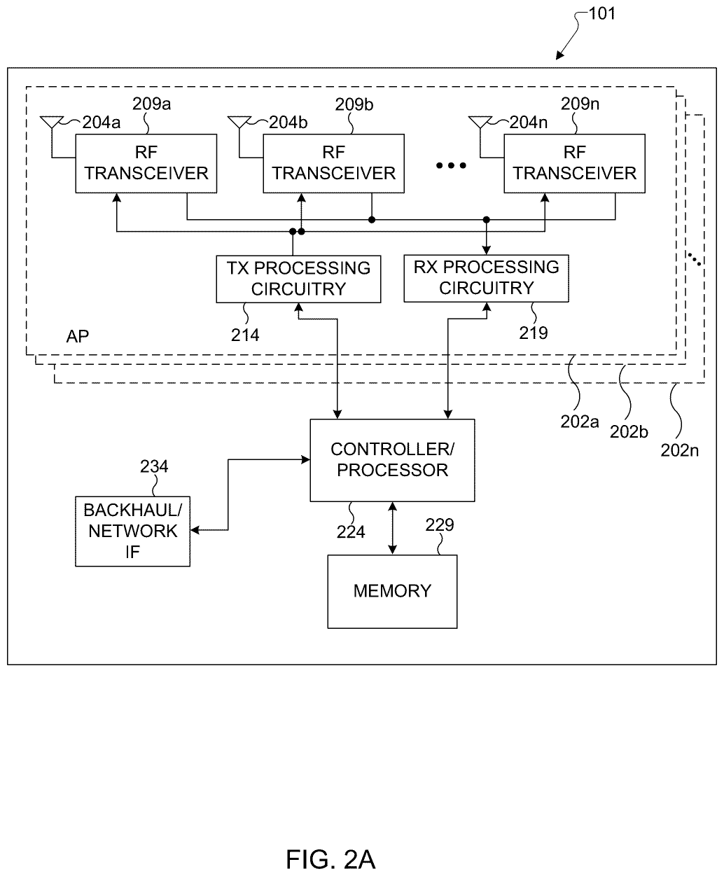

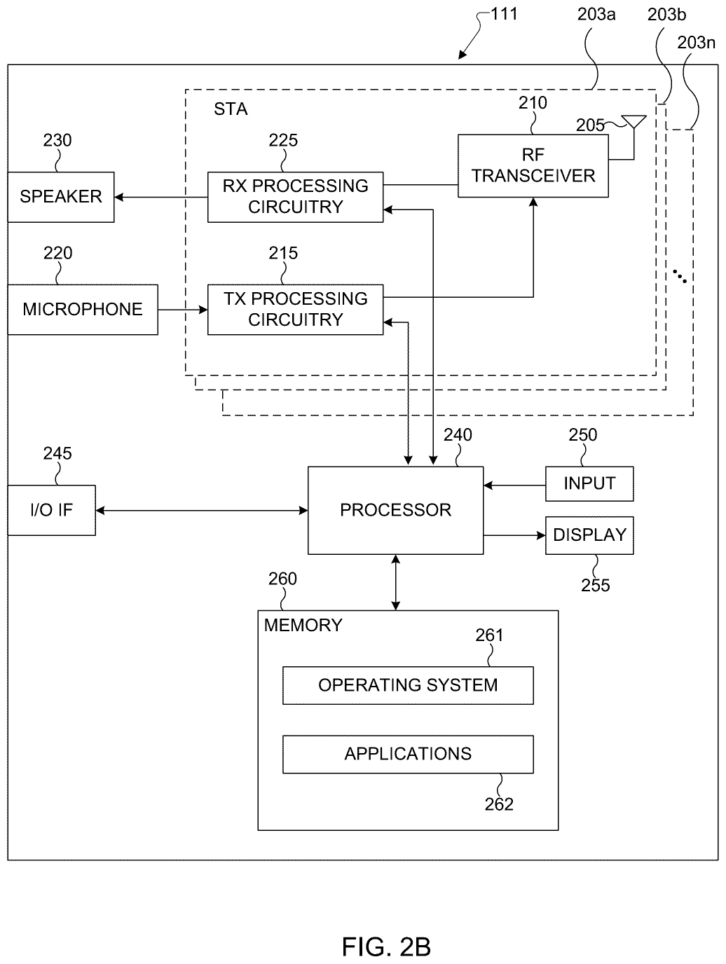

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed herein below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHz, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHz, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP MLD 101 by the controller/processor 224 including facilitating improved TWT operation between devices in WLANs. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connections. For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for facilitating improved TWT operation between devices in WLANs. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed herein below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antennas 205, a radio frequency (RF) transceiver 210, TX processing circuitry 215, and receive (RX) processing circuitry 225. The non-AP MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives, from the antennas 205, an incoming RF signal transmitted by an AP of the network 100. In some embodiments, each affiliated STA 203a-203n operates at a different bandwidth, e.g., 2.4 GHz, 5 GHz, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antennas 205. In embodiments wherein each affiliated STA 203a-203n operates at a different bandwidth, e.g., 2.4 GHz, 5 GHz, or 6 GHz, the outgoing RF signals transmitted by each affiliated STA may be at a different frequency of RF.

The controller/processor 240 can include one or more processors and execute the basic OS program 261 stored in the memory 260 in order to control the overall operation of the non-AP MLD 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to facilitate improved TWT operation between devices in WLANs. In some embodiments, the controller/processor 240 includes at least one microprocessor or microcontroller.

The controller/processor 240 is also capable of executing other processes and programs resident in the memory 260, such as operations for facilitating improved TWT operation between devices in WLANs. The controller/processor 240 can move data into or out of the memory 260 as required by an executing process. In some embodiments, the controller/processor 240 is configured to execute a plurality of applications 262, such as applications for facilitating improved TWT operation between devices in WLANs. The controller/processor 240 can operate the plurality of applications 262 based on the OS program 261 or in response to a signal received from an AP. The main controller/processor 240 is also coupled to the I/O interface 245, which provides non-AP MLD 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the non-AP MLD 111 can use the touchscreen 250 to enter data into the non-AP MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antennas 205 for MIMO communication with an AP 101. In another example, the non-AP MLD 111 may not include voice communication or the controller/processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

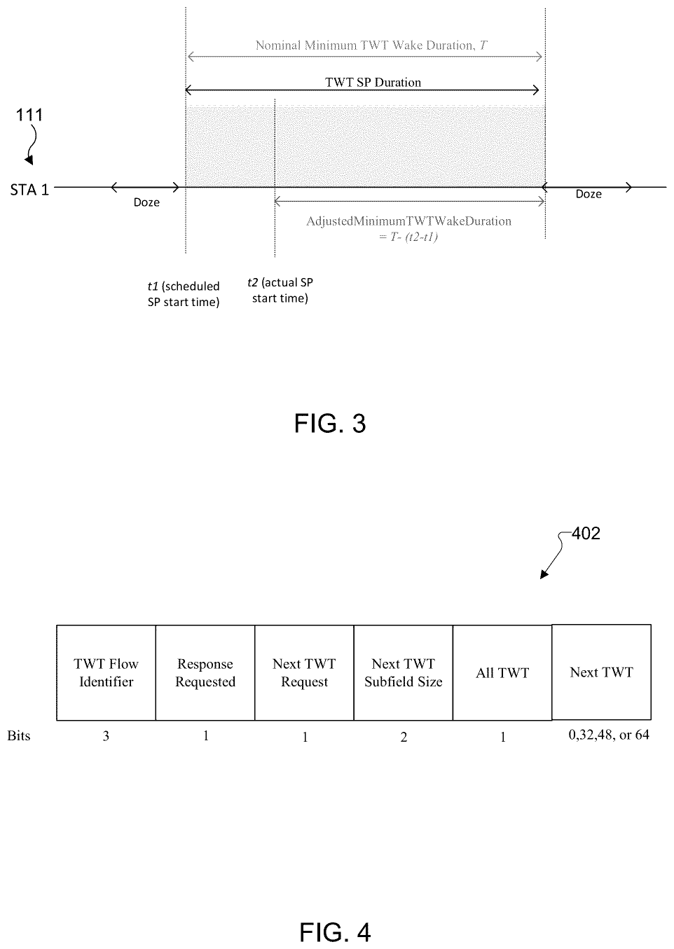

FIG. 3 illustrates an example of different timing components pertaining to a TWT SP according to embodiments of the present disclosure. In this example, STA1 may be a non-AP STA such as a STA 111. STA1 is a TWT scheduled STA and AP1 (not illustrated) is its associated TWT scheduling AP.

STA1 establishes a broadcast TWT schedule with AP1. t1 is the value of the target wake time indicated in the Target Wake Time field in the Broadcast TWT Parameter Set field of the TWT element. Hence, t1 is the time when STA1 should ideally be able to start frame exchanges with AP1. Starting from t1, the time duration the STA is required to remain awake is the value of the nominal wake time (T) indicated in the Nominal Minimum TWT Wake Duration field in the Broadcast TWT Parameter Set field. For various reasons, it may not be possible for STA1 to start frame exchanges with AP1 at the nominal SP start time, t1. The actual SP start time can be much later. In the figure, the actual SP start time is indicated as time t2. With the delayed actual SP start time, the minimum wake duration for STA1 is also adjusted and is indicated as the AdjustedMinimumTWTWakeDuration=T−(t2−t1).

A TWT Information frame is sent by a STA to request or deliver information about a TWT, and is transmitted by a STA of a TWT agreement or TWT schedule, or is transmitted by a STA to its peer STA. The format of the TWT Information frame is shown in Table 1.

TABLE 1

| Order | Information |
|---|---|
| 1 | Category |
| 2 | Unprotected SIG Action |
| 3 | TWT Information field |

FIG. 4 illustrates an example format of the TWT Information field 402 in the TWT Information frame of Table 1 according to embodiments of the present disclosure.

According to one embodiment, using a variant of the TWT Information frame, it can be possible to suspend or resume a particular broadcast TWT schedule for a STA that is a member of the corresponding schedule.

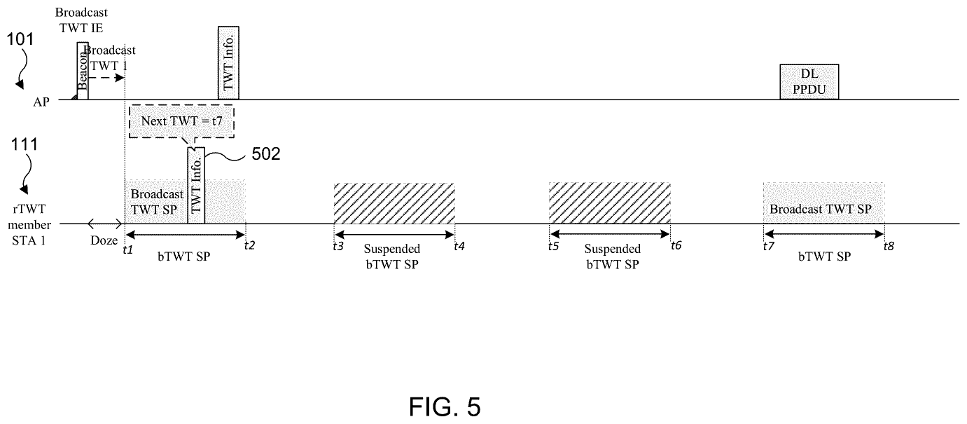

FIG. 5 illustrates an example of broadcast TWT schedule suspension for a particular broadcast TWT schedule according to embodiments of the present disclosure. In this example, the AP may be an AP 101, and the STA1 may be a non-AP STA such as STA 111. In the example of FIG. 5, a TWT Information frame 502 is used by STA1 to suspend the broadcast TWT schedule until time t7.

According to one embodiment, using a variant of TWT the Information frame, it can be possible to suspend or resume a particular broadcast TWT schedule for a STA that is a member of the corresponding schedule while keeping any other TWT agreement or schedule the STA may be a member of uninterrupted.

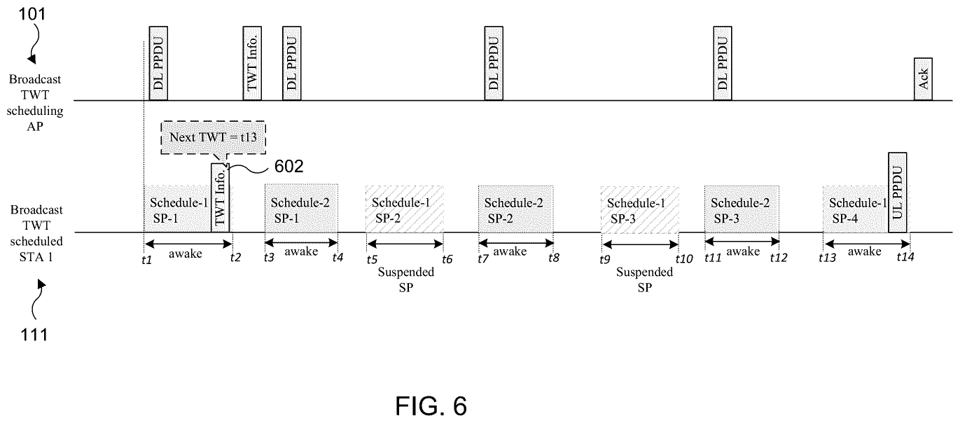

FIG. 6 illustrates an example of broadcast TWT schedule suspension for a particular broadcast TWT schedule while other broadcast TWT schedules are maintained according to embodiments of the present disclosure. In this example, the AP may be an AP 101, and the STA1 may be a non-AP STA such as STA 111. In the example of FIG. 6, a TWT Information frame 602 is used by STA1 to suspend the broadcast TWT schedule indicated as Schedule-1 until time t13. Meanwhile, the broadcast TWT schedule indicated as Schedule-2 is maintained.

According to one embodiment, in order to indicate that a TWT Information frame is intended for a particular broadcast TWT schedule, an identifier to specify the corresponding broadcast TWT schedule can be included in the TWT Information field. According to one embodiment, the Broadcast TWT ID subfield can be included in the TWT Information field. Such a modified (with respect to the existing specification) TWT Information field can be referred to as an EHT Variant TWT Information field.

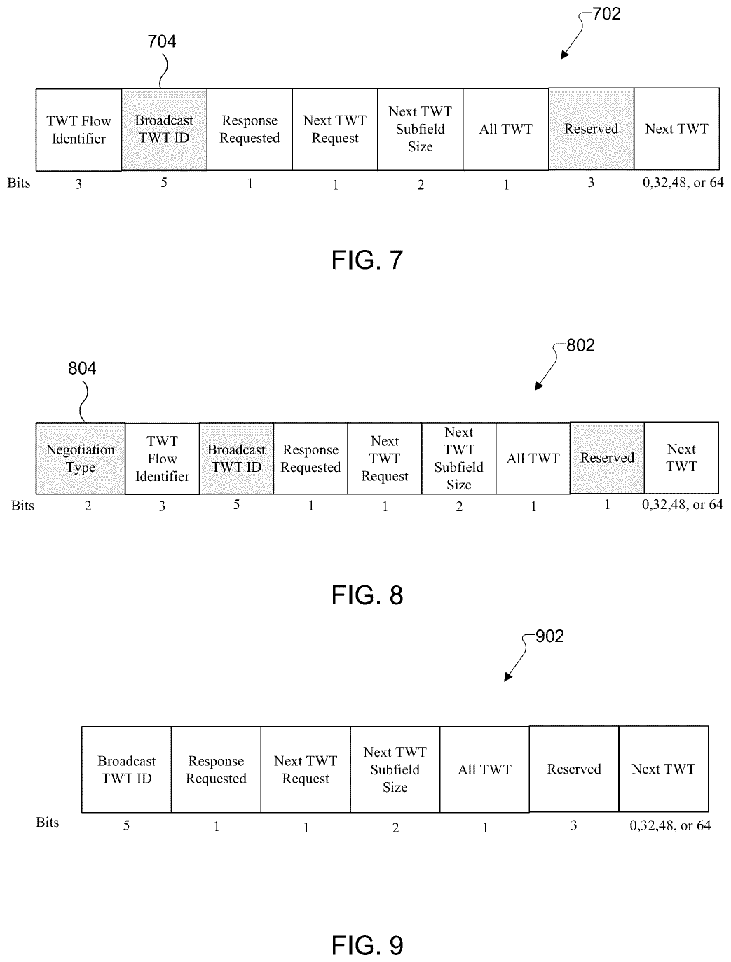

FIG. 7 illustrates an example format of an EHT Variant TWT Information field 702 including a Broadcast TWT ID subfield 704 according to embodiments of the present disclosure. The interpretations and usage of the TWT Flow Identifier subfield, Response Requested subfield, Next TWT Request subfield, Next TWT Subfield Size subfield, All TWT subfield, and the Next TWT subfield in the EHT Variant TWT Information field 702 are the same as that of the TWT Information field (e.g., the TWT Information field 402 of FIG. 4). The Broadcast TWT ID subfield 704 in the EHT Variant TWT Information field 702 can be the same value as the value of the Broadcast TWT ID subfield in the Broadcast TWT Info subfield in the Broadcast TWT Parameter Set field corresponding to the broadcast TWT schedule intended to be suspended or resumed by the TWT Information field.

A STA in the BSS can be a member of one or more broadcast TWT schedules as well as member of one or more individual TWT agreements. In order to distinguish whether an EHT Variant TWT Information field is intended for a particular broadcast TWT schedule or individual TWT agreement, an indicator subfield can be introduced in the EHT Variant TWT Information field. For example, if the indicator subfield is set to 0, it may indicate that the corresponding EHT Variant TWT Information field is intended for an individual TWT agreement that the STA is subscribed to. Otherwise, it may indicate that the corresponding EHT Variant TWT Information field is intended for a broadcast TWT schedule that the STA is a member of, or vice versa.

According to another embodiment, a Negotiation Type subfield can be included in the EHT Variant TWT Information field to specify whether the TWT Information frame is intended for an individual TWT agreement, broadcast TWT schedule, or both.

FIG. 8 illustrates an example format of an EHT Variant TWT Information field 802 including a Negotiation Type subfield 804 according to embodiments of the present disclosure. The encoding of the Negotiation Type subfield 804 values in the EHT Variant TWT Information field 802 is shown in Table 2.

TABLE 2

| Value | Description |
|---|---|
| 0 | The EHT Variant TWT Information field is |
| | intended for an individual TWT agreement the |
| | STA is subscribed to. The corresponding |
| | individual TWT agreement is identified by the |
| | TWT Flow Identifier subfield of the EHT |
| | Variant TWT Information field. |
| 1 | The EHT Variant TWT Information field is |
| | intended for a broadcast TWT schedule the |
| | STA is a member of. The corresponding |
| | broadcast TWT schedule is identified by the |
| | Broadcast TWT ID subfield of the EHT Variant |
| | TWT Information field. |
| 2 | The EHT Variant TWT Information field is |
| | intended for both individual TWT agreement |
| | and broadcast TWT schedule the STA is |
| | subscribed to. The corresponding individual |
| | TWT agreement is identified by the TWT Flow |
| | Identifier subfield of the EHT Variant TWT |
| | Information field. The corresponding broadcast |
| | TWT schedule is identified by the Broadcast |
| | TWT ID subfield of the EHT Variant TWT |
| | Information field. |
| 3 | Reserved |

According to one embodiment, the Value 2 in Table 2 can be used in conjunction with the All TWT subfield of the EHT Variant TWT Information field 802. For example, if the All TWT subfield in the EHT Variant TWT Information field 802 is set to 1, the Negotiation Type subfield 804 in the EHT Variant TWT Information field 802 can be set to 2 to indicate that all TWTs—both individual TWT agreements and broadcast TWT schedules—are intended (i.e., intended to be suspended or resumed) by this EHT Variant TWT Information field.

According to one embodiment, if the Negotiation Type subfield in the EHT Variant TWT Information field is set to 0, then the Broadcast TWT ID subfield in the EHT Variant TWT Information field is reserved.

According to another embodiment, if the Negotiation Type subfield in the EHT Variant TWT Information field is set to 1, then the TWT Flow Identifier subfield in the EHT Variant TWT Information field is reserved.

According to one embodiment, if the All TWT subfield is set to 1, it indicates that all the individual TWT agreements subscribed by the STA are intended by the EHT Variant TWT Information field. According to another embodiment, it can indicate that all the broadcast TWT schedules in which the STA is a member are intended by the EHT Variant TWT Information field. According to yet another embodiment, it can indicate that both the individual TWT agreements and broadcast TWT schedules are intended by the EHT Variant TWT Information field.

According to one embodiment, if the All TWT subfield in the EHT Variant TWT Information field is set to 1, then the TWT Flow Identifier subfield and the Broadcast TWT ID subfield can be reserved. According to one embodiment, if the All TWT subfield is set to 1, then the Negotiation Type subfield can be reserved.

According to one embodiment, if the All TWT subfield in the EHT Variant TWT Information field is set to 1 and the Negotiation Type subfield is set to 0, it can indicate that all the individual TWT agreements subscribed by the STA are intended by the EHT Variant TWT Information field. In such cases, according to one embodiment, the TWT Flow Identifier subfield can be reserved and the Broadcast TWT ID subfield can also be reserved. According to another embodiment, if the All TWT subfield in the EHT Variant TWT Information field is set to 1 and the Negotiation Type subfield is set to 1, it can indicate that all the broadcast TWT schedules in which the STA is a member are intended by the EHT Variant TWT Information field. In such cases, according to one embodiment, the Broadcast TWT ID subfield in the EHT Variant TWT Information field can be reserved and the TWT Flow Identifier subfield can also be reserved.

According to one embodiment, if the All TWT subfield in the EHT Variant TWT Information field is set to 0, the EHT Variant TWT Information field can be intended for, as specified by the Negotiation Type subfield, either a particular broadcast TWT schedule, indicated by the Broadcast TWT ID subfield, or a particular individual TWT agreement, indicated by the TWT Flow Identifier subfield.

A possible interpretation and usage of the All TWT subfield in conjunction with the Negotiation Type subfield in the EHT Variant TWT Information field is illustrated in Table 3. Other interpretations and usages are also possible.

TABLE 3

| Negotiation | All | |
|---|---|---|
| Type | TWT | |
| subfield | subfield | Description |
| 0 | 0 | The EHT Variant TWT Information field is |
| | | intended for an individual TWT agreement the |
| | | STA is subscribed to. The corresponding |
| | | individual TWT agreement is identified by the |
| | | TWT Flow Identifier subfield of the EHT |
| | | Variant TWT Information field. |
| 1 | 0 | The EHT Variant TWT Information field is |
| | | intended for a broadcast TWT schedule the |
| | | STA is a member of. The corresponding |
| | | broadcast TWT schedule is identified by the |
| | | Broadcast TWT ID subfield of the EHT Variant |
| | | TWT Information field. |
| 2 | 0 | The EHT Variant TWT Information field is |
| | | intended for an individual TWT agreement, as |
| | | identifier by the TWT Flow Identifier subfield, |
| | | and a broadcast TWT schedule, as identified by |
| | | the Broadcast TWT ID subfield of the EHT |
| | | Variant TWT Information field. |
| 3 | 0 | The EHT Variant TWT Information field is |
| | | intended for all individual TWT agreements |
| | | and broadcast TWT schedules that are |
| | | subscribed by the STA except for all the |
| | | restricted TWT schedules that are subscribed |
| | | the STA. All the restricted TWT schedules for |
| | | which the STA has obtained memberships |
| | | remain unchanged. |
| 0 | 1 | The EHT Variant TWT Information field is |
| | | intended for all individual TWT agreements |
| | | that are subscribed by the STA. |
| 1 | 1 | The EHT Variant TWT Information field is |
| | | intended for all broadcast TWT schedules in |
| | | which the STA is a member. |
| 2 | 1 | The EHT Variant TWT Information field is |
| | | intended for all individual TWT agreements |
| | | and broadcast TWT schedules that are |
| | | subscribed by the STA. |
| 3 | 1 | The EHT Variant TWT Information field is |
| | | intended for all restricted TWT schedules that |
| | | are subscribed by the STA. |

According to one embodiment, the frame carrying the EHT Variant TWT Information field can be referred to as an EH-T Variant TWT Information frame. A possible EHT Variant TWT Information frame format is shown in Table 4.

TABLE 4

| Order | Information |
|---|---|
| 1 | Category |
| 2 | Unprotected S1G Action |
| 3 | EHT Variant TWT Information field |

According to one embodiment, the Unprotected SIG Action field values can contain one value for EHT Variant TWT Information field. For example, according to one embodiment, value 10 can be used, or any value currently reserved, from values 12-255, can be used as shown in Table 4A.

TABLE 4A

| Value | Meaning | Time Priority |
|---|---|---|
| 0 | AID Switch Request | No |
| 1 | AID Switch Response | No |
| 2 | Sync Control | No |
| 3 | STA Information Announcement | No |
| 4 | EDCA Parameter Set | No |
| 5 | EL Operation | No |
| 6 | TWT Setup | No |
| 7 | TWT Teardown | No |
| 8 | Sectorized Group ID List | No |
| 9 | Sector ID Feedback | No |
| 10 | Reserved | |
| 11 | TWT Information | No |
| 12 | EHT Variant TWT Information field | No |
| 13-255 | Reserved | |

According to another embodiment, both the TWT Information field and the EHT Variant TWT Information field can be included in the EHT Variant TWT Information frame as shown in Table 5.

TABLE 5

| Order | Information |
|---|---|
| 1 | Category |
| 2 | Unprotected S1G Action |
| 3 | TWT Information field |
| 4 | EHT Variant TWT Information field |

According to one embodiment, a TWT Information frame can be specific for broadcast TWT. Such a TWT Information frame can be referred to as a Broadcast TWT Information frame. A Broadcast TWT Information frame can contain a Broadcast TWT Information field.

FIG. 9 illustrates an example format of a Broadcast TWT Information field 902 according to embodiments of the present disclosure.

According to one embodiment, the Broadcast TWT Information frame is intended for a broadcast TWT schedule subscribed by a STA and identified by the Broadcast TWT ID subfield of the Broadcast TWT Information field 902. According to another embodiment, the Broadcast TWT Information frame is intended for all broadcast TWT schedules subscribed by a STA if the All TWT subfield of the Broadcast TWT Information field 902 is set to 1, in which case the Broadcast TWT ID subfield can be reserved.

According to another embodiment, a TWT Information frame can be specific for restricted TWT. Such a TWT Information frame can be referred to as a Restricted TWT Information frame. A Restricted TWT Information frame can contain a Restricted TWT Information field. The format of the Restricted TWT Information field can be same as that of the Broadcast TWT Information field 902. According to one embodiment, a Restricted TWT Information frame is intended for one or more restricted TWT schedules, and may not be applicable for other broadcast TWT schedules that are not restricted TWT schedules, or for other individual TWT agreements.

Restricted TWT operation supports latency sensitive applications for a STA. A STA may need to prioritize its latency sensitive applications over its power saving needs. While suspending or resuming all TWT SPs by setting the All TWT subfield of a TWT Information frame, an r-TWT scheduled STA may want to exclude its restricted TWT schedules from suspension (or resumption). In order to enable such an operation, a Restricted TWT Excluded subfield can be included in the EHT Variant TWT Information field as an indicator for exclusion or inclusion of the restricted TWT schedules.

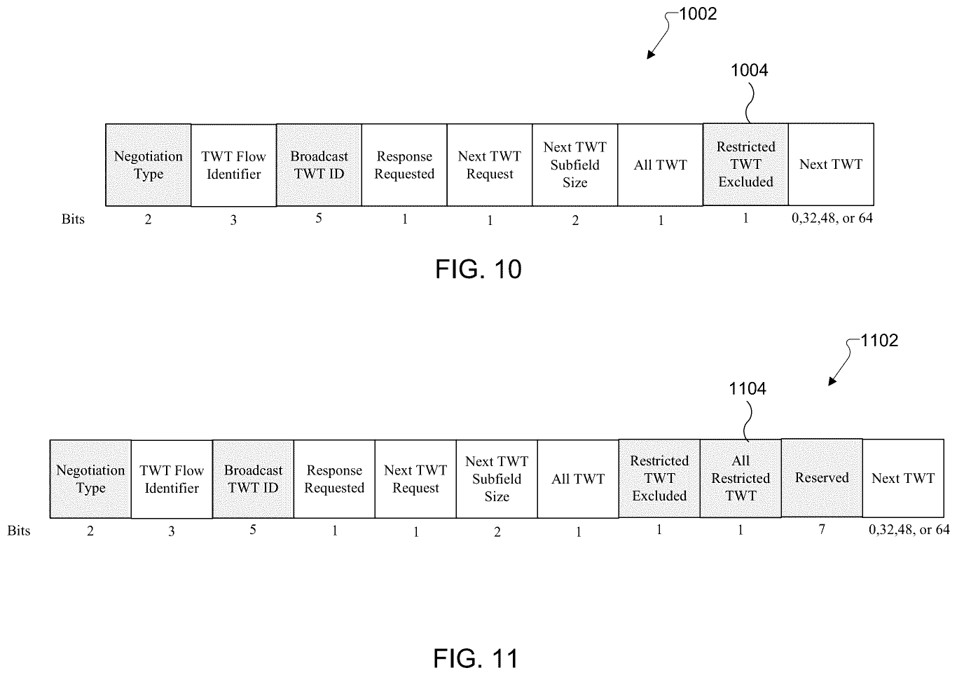

FIG. 10 illustrates an example format of an EHT Variant TWT Information field 1002 including a Restricted TWT Excluded subfield 1004 according to embodiments of the present disclosure. If the All TWT subfield is set to 1 and the Restricted TWT Excluded subfield 1004 is set to 1, it may indicate that all broadcast TWT schedules or individual TWT agreements are intended by the EHT Variant TWT Information field 1002 (e.g., for suspending or resuming TWT SPs) except for the restricted TWT schedules in which the STA is a member.

According to one embodiment, in reference to FIG. 10 and Table 3, if All TWT subfield is set to 0, the Restricted TWT Excluded subfield 1004 can be reserved.

According to another embodiment, in reference to FIG. 10 and Table 3, if All TWT subfield is set to 1 and the Negotiation Type subfield is set to 0, the Restricted TWT Excluded subfield 1004 can be Reserved.

According to another embodiment, in reference to FIG. 10 and Table 3, if All TWT subfield is set to 1 and the Negotiation Type subfield is set to 3, the Restricted TWT Excluded subfield 1004 can be Reserved.

According to another embodiment, in reference to FIG. 10 and Table 3, if All TWT subfield is set to 1 and the Negotiation Type subfield is set to 1, and if the Restricted TWT Excluded subfield 1004 is set to 1, then it can indicate that the EHT Variant TWT Information field is intended for (e.g., for suspension or resumption of) all broadcast TWT schedules the STA is a member of except the restricted TWT schedules the STA is a member of. According to another embodiment, if All TWT subfield is set to 1 and the Negotiation Type subfield is set to 1, and if the Restricted TWT Excluded subfield 1004 is set to 0, then it can indicate that the EHT Variant TWT Information field is intended for (e.g., for suspension or resumption of) all broadcast TWT schedules the STA is a member of including the restricted TWT schedules the STA is a member of.

According to another embodiment, in reference to FIG. 10 and Table 3, if All TWT subfield is set to 1 and the Negotiation Type subfield is set to 2, and if the Restricted TWT Excluded subfield 1004 is set to 1, then it can indicate that the EHT Variant TWT Information field is intended for (e.g., for suspension or resumption of) all individual TWT agreements and broadcast TWT schedules the STA is a member of except the restricted TWT schedules the STA is a member of. According to another embodiment, if All TWT subfield is set to 1 and the Negotiation Type subfield is set to 2, and if the Restricted TWT Excluded subfield 1004 is set to 0, then it can indicate that the EHT Variant TWT Information field is intended for (e.g., for suspension or resumption of) all individual TWT agreements and broadcast TWT schedules the STA is a member of including the restricted TWT schedules the STA is a member of.

According to one embodiment, if the All TWT subfield is set to 1, the Restricted TWT Excluded subfield 1004 can be reserved.

FIG. 11 illustrates an example format of an EHT Variant TWT Information field 1102 including an All Restricted TWT subfield 1104 according to embodiments of the present disclosure. If the All Restricted TWT subfield 1104 is set to 1, it indicates that the TWT Information frame is intended for (e.g. for suspension and resumption of) all restricted TWT schedules of which the R-TWT scheduled STA that receives or transmits the EHT Variant TWT Information field 1102 is a member. According to one embodiment, if the All Restricted TWT subfield 1104 is set to 1, then the Restricted TWT Excluded subfield can be reserved. According to another embodiment, if the Restricted TWT Excluded subfield is set to 1, then the All Restricted TWT subfield 1104 can be reserved. According to one embodiment, if the All Restricted TWT subfield 1104 is set to 1, then the TWT Flow Identifier subfield and the Broadcast TWT ID subfield can be reserved.

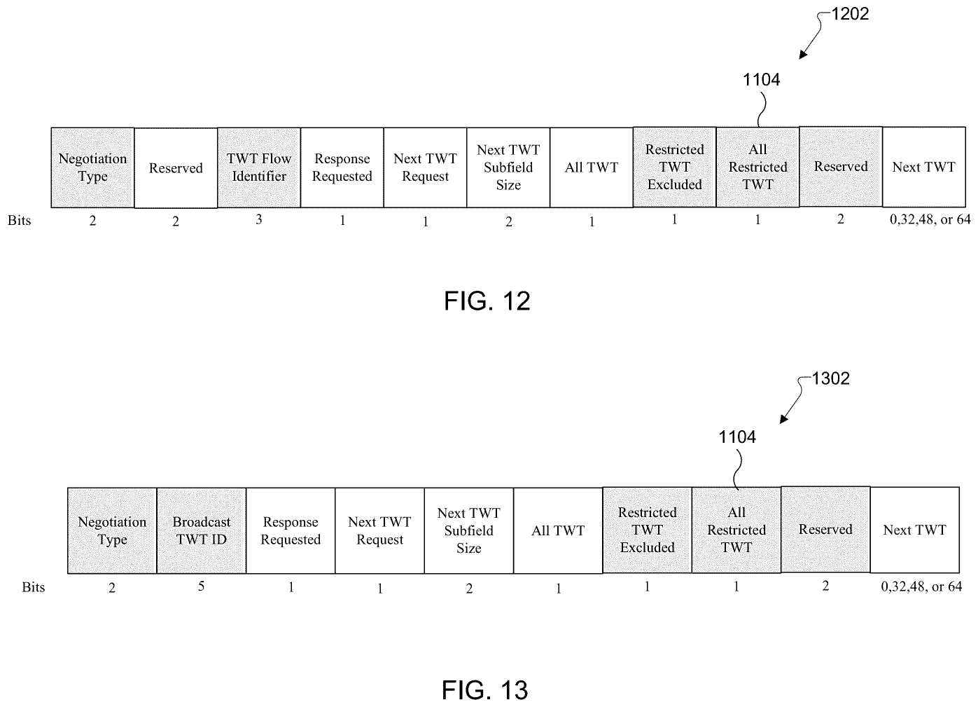

FIG. 12 illustrates an example format of an EHT Variant TWT Information field 1202 including an All Restricted TWT subfield 1104 when Negotiation Type subfield is set to 0 and All TWT subfield is set to 0 according to embodiments of the present disclosure. With reference to FIG. 11, if the Negotiation Type subfield is set to 0 and the All TWT subfield is set to 0, then the format of the EHT Variant TWT Information field 1202 may be used.

FIG. 13 illustrates an example format of an EHT Variant TWT Information field 1302 including an All Restricted TWT subfield 1104 when Negotiation Type subfield is set to 0 and All TWT subfield is set to 0 according to embodiments of the present disclosure. With reference to FIG. 11, if the Negotiation Type subfield is set to 0 and the All TWT subfield is set to 0, then the format of the EHT Variant TWT Information field 1302 may be used.

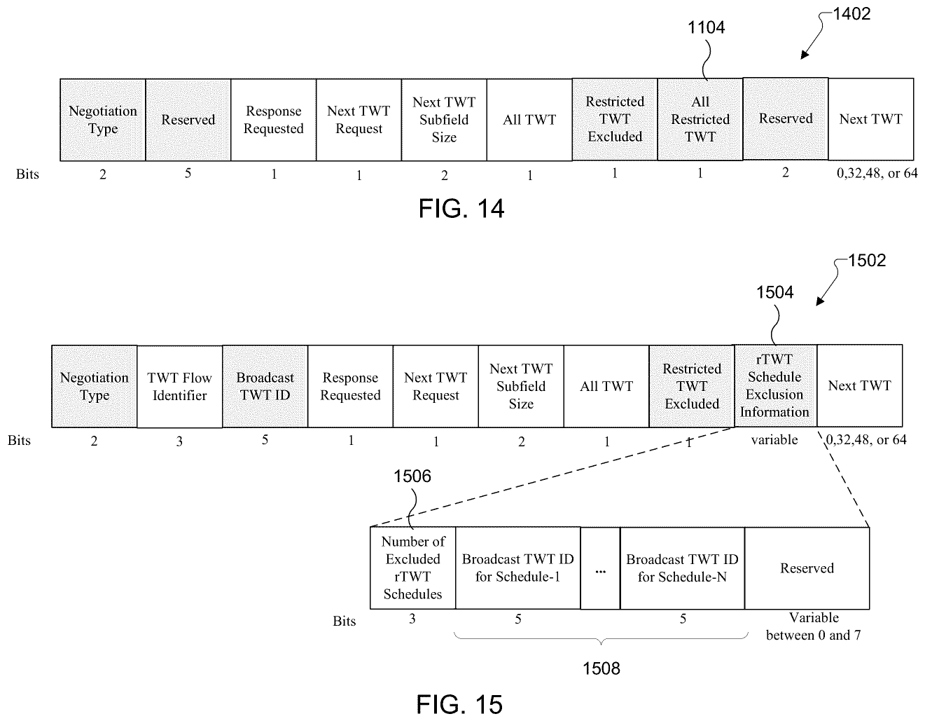

FIG. 14 illustrates an example format of an EHT Variant TWT Information field 1402 including an All Restricted TWT subfield 1104 according to embodiments of the present disclosure. With reference to FIG. 11, the EHT Variant TWT Information field 1402 may be used when any of the following cases occur: All TWT subfield is set to 1, Negotiation Type subfield is set to 2 or 3, or All Restricted TWT subfield is set to 1.

According to another embodiment, restricted TWT schedules can be selectively excluded. In order to enable this, another format of the EHT Variant TWT Information field can be used.

FIG. 15 illustrates an example format of an EHT Variant TWT Information field 1502 enabling selective exclusion of restricted TWT schedules using an rTWT Schedule Exclusion Information subfield 1504 according to embodiments of the present disclosure. According to one embodiment, the Number of Excluded rTWT Schedules subfield 1506 indicates the number of rTWT schedules that are excluded from the list of TWT schedules or agreement intended by the EHT Variant TWT Information field 1502.

In FIG. 15, ‘N’ can be the number of r-TWT schedules that are excluded. This value can be the value set in the Number of Excluded rTWT Schedules subfield 1506. For example, if the Number of Excluded rTWT Schedules subfield is set to 2, there can be two Broadcast TWT ID subfields 1508 in the rTWT Schedule Exclusion Information subfield 1504 after the Number of Excluded rTWT Schedules subfield 1506—the first Broadcast TWT ID corresponds to the first restricted TWT schedule that is excluded (e.g., Schedule-1), and the second Broadcast TWT ID corresponds to the second restricted TWT schedule that is excluded (e.g., Schedule-2). Accordingly, the number of Reserved bits in the rTWT Schedule Exclusion Information subfield 1504 can be 3 (i.e., the number of bits required to make the total number of bits in the rTWT Schedule Exclusion Information subfield an integer multiple of 8).

According to one embodiment, if the Restricted TWT Excluded subfield in the EHT Variant TWT Information field 1502 is set to 0, then the rTWT Schedule Exclusion Information subfield 1504 can be reserved.

According to one embodiment, in reference to FIG. 15, a Length subfield can be included in the rTWT Schedule Exclusion Information subfield in the EHT Variant TWT Information field to indicate the length of the rTWT Schedule Exclusion Information subfield. The length can be indicated in terms of octets.

According to another embodiment, in reference to FIG. 15, an All R-TWT subfield can be included in rTWT Schedule Exclusion Information subfield in the EHT Variant TWT Information field. The All R-TWT subfield may indicate that all restricted TWT schedules the STA is a member of are intended by the EHT Variant TWT Information field.

According to one embodiment, it may be possible to use same information frame to suspend or resume multiple TWT schedules or agreements. In order to enable this, a Generalized TWT Information frame can be used. The format of the Generalized TWT Information frame is shown in Table 6.

TABLE 6

| Order | Information |
|---|---|
| 1 | Category |
| 2 | Unprotected S1G Action |
| 3 | Generalized TWT Information field |

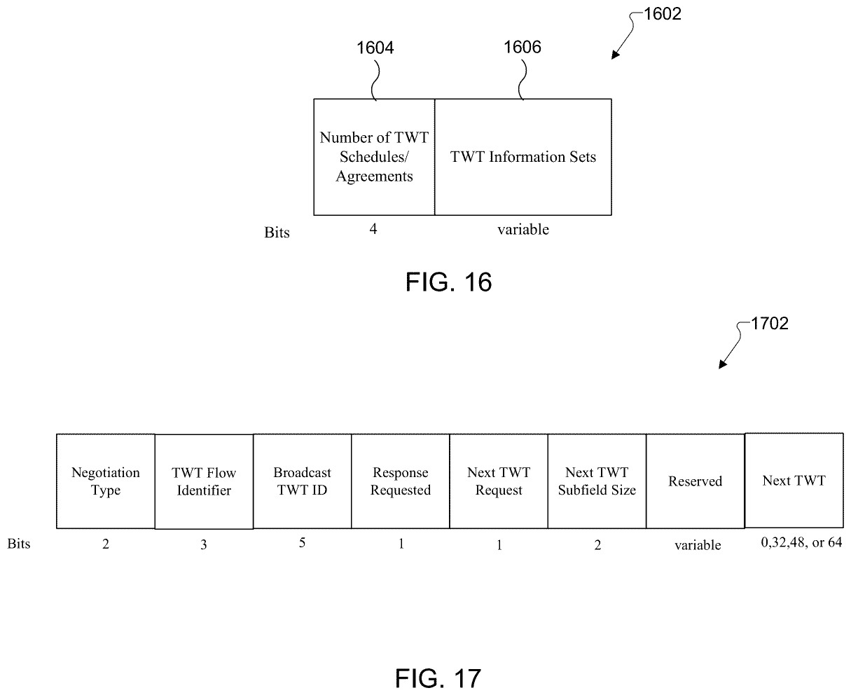

FIG. 16 illustrates an example format of a Generalized TWT Information field 1602 of the Generalized TWT Information frame of Table 6 according to embodiments of the present disclosure. In FIG. 16, the Number of TWT Schedules/Agreements subfield 1604 indicates the number of broadcast TWT schedules or individual TWT agreements whose information is provided by the Generalized TWT Information frame 1602. The TWT Information Sets subfield 1606 contains one or more TWT Information Set subfields as specified by the value set in the Number of TWT Schedules/Agreements subfield 1604.

FIG. 17 illustrates an example format of a TWT Information Set subfield 1702 according to embodiments of the present disclosure. One or more TWT Information Set subfields 1702 may be included in the TWT Information Sets subfield 1606 of FIG. 16.

In FIG. 17, the Negotiation Type subfield indicates whether the TWT Information Set is for an individual TWT agreement, as identified by the TWT Flow Identifier subfield in the TWT Information Set subfield, or for a broadcast TWT schedule, as identified by the Broadcast TWT ID subfield in the TWT Information Set subfield.

According to one embodiment, the frame for providing TWT information can be specific to restricted TWT. For this purpose, a Generalized Restricted TWT Information frame can be used. The format of the Generalized Restricted TWT Information frame is shown in Table 7.

TABLE 7

| Order | Information |
|---|---|
| 1 | Category |
| 2 | Unprotected S1G Action |
| 3 | Generalized Restricted TWT Information field |

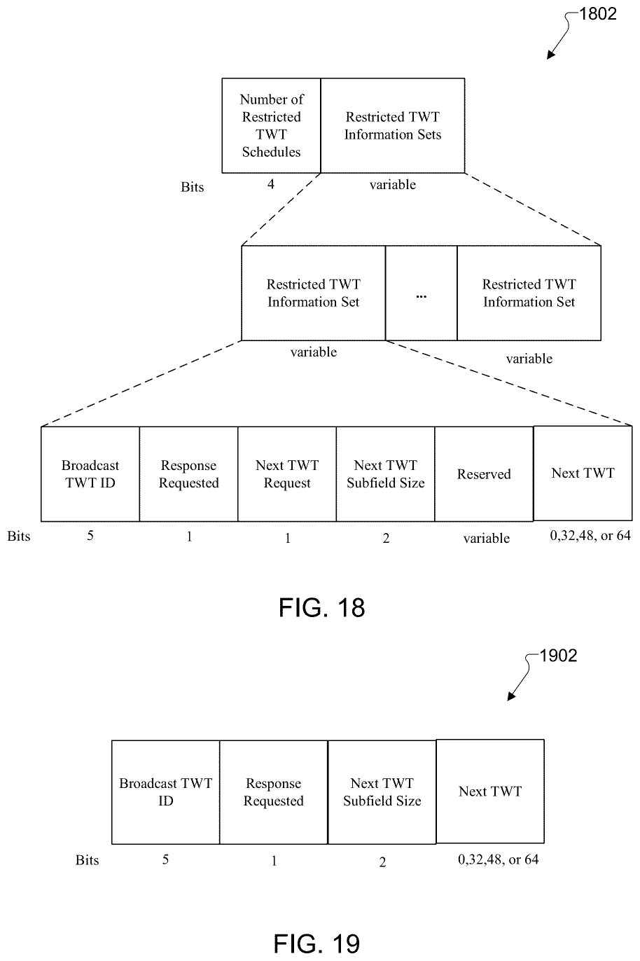

FIG. 18 illustrates an example format of a Generalized Restricted TWT Information field 1802 of the Generalized Restricted TWT Information frame of Table 7 according to embodiments of the present disclosure.

According to one embodiment, if an r-TWT schedule of an r-TWT scheduled STA is suspended (for example, by using an EHT Variant TWT Information frame, or a Generalized TWT Information frame, or a Generalized Restricted TWT Information frame) then the STA, until the r-TWT schedule is resumed, can behave during the suspended restricted TWT SPs as if the STA is not a member of the corresponding restricted TWT schedule. For example, according to this embodiment, the STA may terminate any transmission opportunity (TXOP) that it may have obtained before the start of the restricted TWT SPs that are suspended for the STA. As another example, according to this embodiment, the STA may observe any quiet interval advertised by the r-TWT scheduling AP to protect the corresponding restricted TWT SPs that are suspended for that STA. According to another embodiment, the STA, even during the suspended r-TWT SPs for the STA, may not end its TXOP before the r-TWT SP start time and may not follow the quiet interval announced by the r-TWT scheduling AP for protecting the corresponding r-TWT SPs.

According to one embodiment, if an r-TWT schedule is suspended for an r-TWT scheduled STA, and if there is no other STA that is a member of that r-TWT schedule, then the STAs that are not the r-TWT scheduled STAs corresponding to the suspended schedule may not need to end their TXOP before the start of the suspended r-TWT SPs. According to another embodiment, the STAs that are not the r-TWT scheduled STAs corresponding to the suspended schedule can ignore the quiet intervals corresponding to the protection of the suspended r-TWT SPs.

According to one embodiment, if multiple STAs are members of an r-TWT schedule, and the r-TWT schedule is suspended for the member STAs at least until time t1, then the r-TWT scheduling AP can send a notification message in the message in its BSS indicating that the r-TWT schedule is suspended in the BSS until time t1. The notification message can be broadcast in nature or can be incorporated in the Beacon frame or Probe Response frame or (Re)Association Response frame. The notification message can include the following information:
An identifier of the restricted TWT schedule that is suspended. For example, the identifier can be the Broadcast TWT ID corresponding to the restricted TWT schedule.
The minimum time when at least one of the STAs that are members of the schedule will resume its r-TWT schedule. For example, there can be three member STAs for the r-TWT schedule. The schedule is suspended for the three STAs until times t1, t2, and t3, respectively, where t1<t2<t3. In the notification message, the AP can include the value of t1. This value can be the next target wake time (Next TWT) value for that schedule.
The size of the next TWT value.
An indication whether a response has been requested or not from the recipient of the message.

According to one embodiment, a Restricted TWT Suspension Information frame can be used by the AP to convey the above information. One possible format of the Restricted TWT Suspension Information frame is shown in Table 8.

TABLE 8

| Order | Information |
|---|---|
| 1 | Category |
| 2 | Unprotected S1G Action |
| 3 | Restricted TWT Suspension Information field |

FIG. 19 illustrates an example format of a Restricted TWT Suspension Information field 1902 of the Restricted TWT Suspension Information frame of Table 8 according to embodiments of the present disclosure.

The Broadcast TWT ID subfield in the Restricted TWT Suspension Information field 1902 specifies the Broadcast TWT ID corresponding to the restricted TWT schedule that is suspended and whose information is carried in the Restricted TWT Suspension Information frame.

The Response Requested subfield in the Restricted TWT Suspension Information field 1902 indicates whether a response frame is requested by the transmitter of the Restricted TWT Suspension Information frame upon reception of the frame by the recipient.

The Next TWT Subfield Size subfield in the Restricted TWT Suspension Information field 1902 indicates the size of the Next TWT subfield of the Restricted TWT Suspension Information field. The encoding of the Next TWT Subfield Size subfield 1902 is shown in Table 9.

TABLE 9

| Next TWT Subfield Size | Size of the Next TWT |
|---|---|
| subfield value | subfield in bits |
| 0 | 0 |
| 1 | 32 |
| 2 | 48 |
| 3 | 64 |

The Next TWT subfield in the Restricted TWT Suspension Information field 1902 is of variable size, which is determined by the value set in the Next TWT Subfield Size subfield based on the encoding described in Table 9. The Next TWT subfield contains the value of the least significant portion of the TSF of the next TWT value for the corresponding restricted TWT schedule whose information is carried in the Restricted TWT Suspension Information frame.

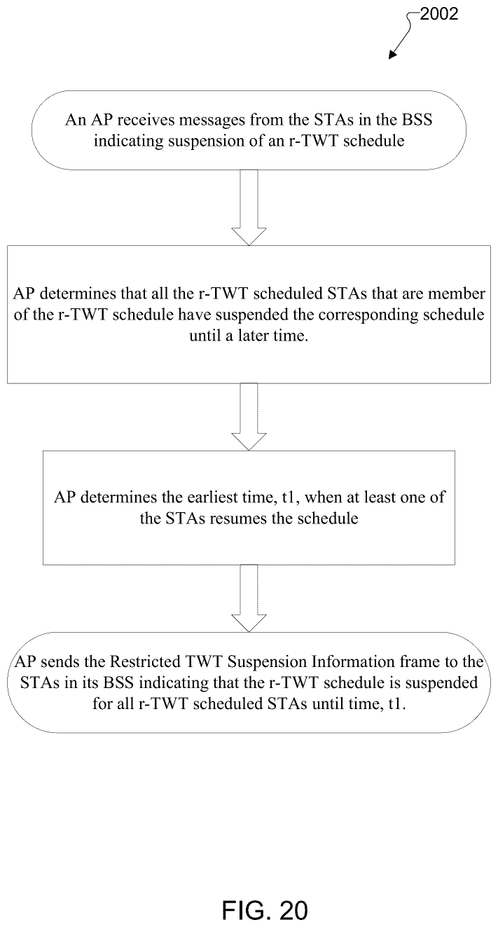

FIG. 20 illustrates a flow chart 2002 of an example behavior of an AP in the context of the usage of the Restricted TWT Suspension Information frame according to embodiments of the present disclosure.

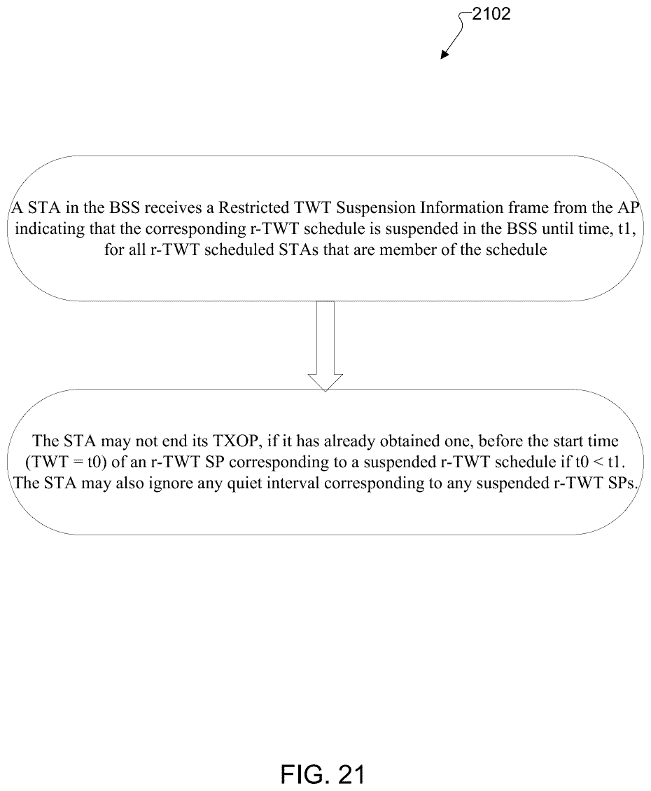

FIG. 21 illustrates a flow chart 2102 of an example behavior of a non-AP STA in the context of the usage of the Restricted TWT Suspension Information frame according to embodiments of the present disclosure.

According to one embodiment, a Generalized Restricted TWT Suspension Information frame can carry r-TWT suspension information for multiple r-TWT schedules. An example format of the Generalized Restricted TWT Suspension Information frame is shown in Table 10.

TABLE 10

| Order | Information |
|---|---|
| 1 | Category |
| 2 | Unprotected S1G Action |
| 3 | Generalized Restricted TWT Suspension |
| | Information field |

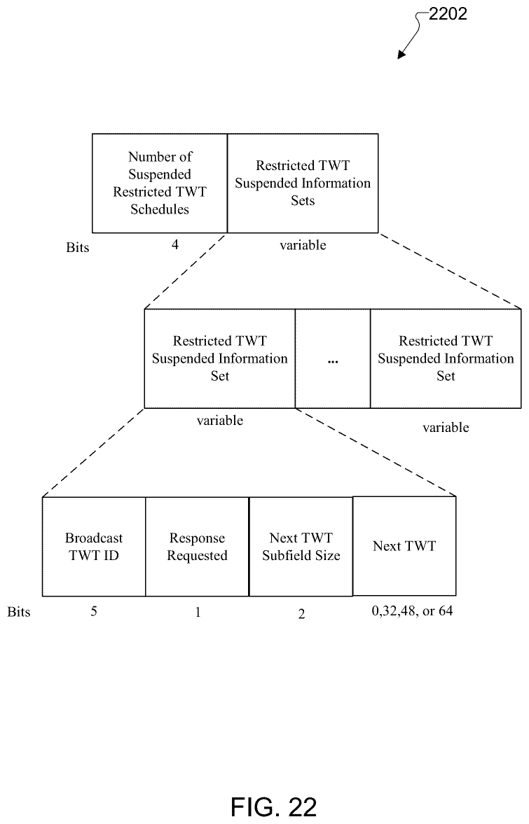

FIG. 22 illustrates an example format of a Generalized Restricted TWT Suspension Information field 2202 of the Generalized Restricted TWT Suspension Information frame of Table 10 according to embodiments of the present disclosure.

According to one embodiment, the information contained in the Restricted TWT Suspension Information frame and the Generalized Restricted TWT Suspension Information frame can also be carried in element formats, for example, by using the Restricted TWT Suspension Information element and the Generalized Restricted TWT Suspension Information element, respectively. The formats of the Restricted TWT Suspension Information element and Generalized Restricted TWT Suspension Information element can be similar to the formats of the Restricted TWT Suspension Information field and Generalized Restricted TWT Suspension Information field, respectively. The Restricted TWT Suspension Information element and Generalized Restricted TWT Suspension Information element can be carried in either a Beacon frame, Probe Response frame, (Re)Association Response frame, or other management or data frame.

According to one embodiment, an AP can use the Restricted TWT Suspension Information frame or the Generalized Restricted TWT Suspension Information frame to notify the STAs in its BSS that the AP is unavailable until the time indicated in the Next TWT subfield in the corresponding frames. According to this embodiment, a STA that receives either the Restricted TWT Suspension Information frame or the Generalized Restricted TWT Suspension Information frame from the AP may not be able to perform a frame exchange with the AP until the time indicated in the Next TWT subfield regardless of whether the STA supports TWT operation or not. An AP that is affiliated with an AP MLD can use this mechanism to temporarily disable a link (e.g., for power saving purposes).

According to one embodiment, a STA affiliated with a non-AP MLD or an AP affiliated with an AP MLD operating on a link can suspend or resume a TWT agreement or TWT schedule that is established over another link between the same AP MLD and the non-AP MLD.

According to one embodiment, when a non-AP MLD is associated with an AP MLD, a STA affiliated with the non-AP MLD and operating on a link between the AP MLD and the non-AP MLD or an AP affiliated with the AP MLD and operating on the link between the AP MLD and the non-AP MLD can send an MLO-Supporting TWT Information frame over that link in order to suspend or resume a TWT agreement or TWT schedule that is established over another link between the same AP MLD and the non-AP MLD. The format and usage of the MLO-Supporting TWT Information frame can be similar to the format and usage of the EHT Variant TWT Information frames disclosed herein above with additional Link-specific TWT information. For example, a Link ID can be included in the MLO-Supporting TWT Information frame in order to indicate which link among the multiple links between the AP MLD and the non-AP MLD the TWT information carried in the MLO-Supporting TWT Information frame is intended for.

According to another embodiment, instead of Link ID information, a Link ID Bitmap can also be used. A possible format of the MLO-Supporting TWT Information frame is shown in Table 11.

TABLE 11

| Order | Information |
|---|---|
| 1 | Category |
| 2 | Unprotected S1G Action |
| 3 | MLO Supporting TWT Information field |

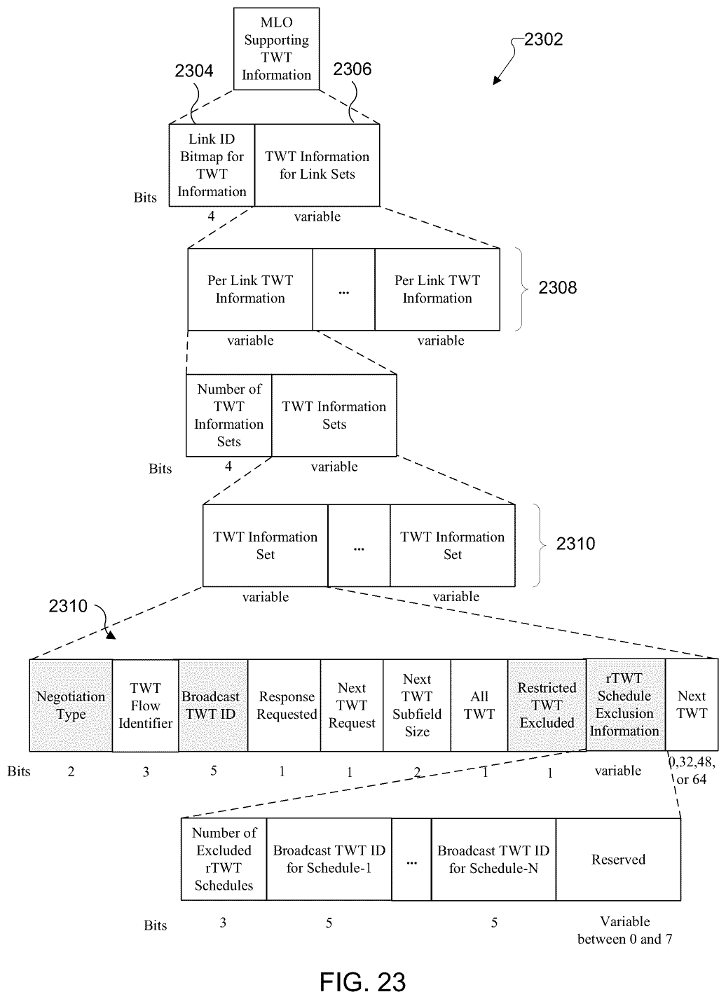

FIG. 23 illustrates an example format of an MLO-Supporting TWT Information field 2302 of the MLO-Supporting TWT Information frame of Table 11 according to embodiments of the present disclosure.

In FIG. 23, the Link ID Bitmap for TWT Information subfield 2304 specifies the MLO links for which the TWT information (e.g., for suspending or resuming TWT SPs for the corresponding TWT schedule or TWT agreement) is provided in the MLO-Supporting TWT Information field 2302. If a bit in the bitmap is set to 1, it can indicate that the corresponding link's TWT information is provided in the MLO-Supporting TWT Information field carrying the bitmap. Otherwise, the corresponding link's TWT information is not provided in the MLO-Supporting TWT Information field.

In FIG. 23, the TWT Information for Link Sets subfield 2306 contains one or more Per Link TWT Information subfields 2308, depending on the total number of is in the Link ID Bitmap for TWT Information subfield 2304.

In the example of FIG. 23, the example TWT Information Set subfield 2310 has the same format as the EHT Variant TWT Information field 1502 of FIG. 15. However, it is understood that the TWT Information Set subfields 2310 could use another format, such as the format of any EHT Variant TWT Information field disclosed herein above.

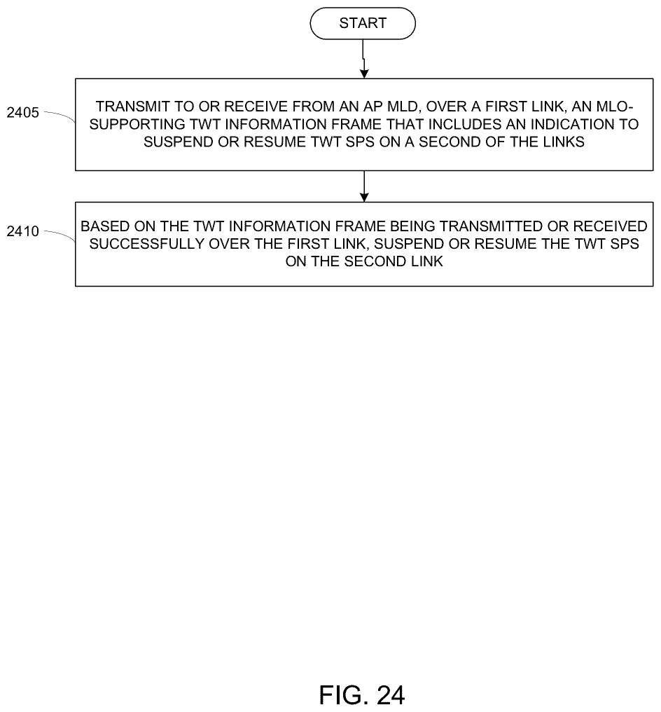

FIG. 24 illustrates an example process for facilitating TWT operation between MLDs using an MLO-Supporting TWT Information frame according to various embodiments of the present disclosure. The process of FIG. 24 is discussed as being performed by a non-AP MLD, but it is understood that a corresponding AP MLD performs a corresponding process. Additionally, for convenience the process of FIG. 24 is discussed as being performed by a WI-FI non-AP MLD comprising a plurality of STAs that each comprise a transceiver configured to configured to form a link with a corresponding AP affiliated with a WI-FI AP MLD. However, it is understood that any suitable wireless communication device could perform these processes.

Referring to FIG. 24, the process begins with the non-AP MLD transmitting to or receiving from an AP MLD, over a first one of links formed between the STAs and APs affiliated with the AP MLD, an MLO-supporting TWT Information frame that includes an indication to suspend or resume TWT SPs on a second of the links (step 2405).

In some embodiments the indication is an indication to suspend or resume an individual TWT agreement that is established on the second link, and the TWT SPs correspond to the individual TWT agreement. In other embodiments the indication is an indication to suspend or resume a broadcast TWT schedule that is established on the second link, and the TWT SPs correspond to the broadcast TWT schedule.

In some embodiments the TWT Information frame (possibly in conjunction with another frame) includes TWT information and a link ID for the second link that indicates that the TWT information is intended for the second link, and the TWT information indicates to suspend or resume the TWT SPs.

In other embodiments the TWT Information frame (possibly in conjunction with another frame) includes TWT information sets respectively intended for one or more links and a link ID bitmap that indicates the one or more links including the second link, and each TWT information set indicates to suspend or resume the TWT SPs on the respective link. In some such embodiments, each TWT information set includes at least one Broadcast TWT ID or TWT Flow ID. The Broadcast TWT ID identifies a broadcast TWT schedule established on the respective link, and the TWT Flow ID identifies an individual TWT agreement established on the respective link. In some such embodiments, TWT SPs are not suspended or resumed on links that are not indicated in the link ID bitmap.

Next, based on the TWT Information frame being transmitted or received successfully over the first link at step 2405, the non-AP MLD suspends or resumes the TWT SPs on the second link (step 2410).

The above flowchart illustrates an example method or process that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

According to one embodiment, the value set in the Next TWT subfields in any of the proposed frames in this disclosure as the schedule resumption time can be drawn from the set of TWTs for a broadcast or restricted TWT schedule that is negotiated between a TWT scheduling AP and a TWT scheduled STA. According to another embodiment, the value set in the Next TWT subfields may not necessarily be drawn from the set of TWTs that is negotiated between a TWT scheduling AP and a TWT scheduled STA, i.e., the Next TWT subfields in the proposed frames can be any positive value (i.e., a Flexible TWT).

According to one embodiment, the EHT Variant TWT Information frame or Generalized TWT Information frame can also be a protected information frame. In such cases, the second field of the corresponding frames can be a Protected Action field.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A non-access point (AP) multi-link device (MLD) comprising:
stations (STAs) comprising transceivers configured to form links with APs, respectively, the APs affiliated with an AP MLD; and
a processor operably coupled to the transceivers,
wherein a first of the transceivers is further configured to transmit to or receive from the AP MLD over a first of the links a multi-link operation (MLO)-supporting target wake time (TWT) Information frame that includes an indication to suspend or resume TWT service periods (SPs) on a second of the links, and
wherein the processor is configured to, based on the TWT Information frame being transmitted or received successfully over the first link, suspend or resume the TWT SPs on the second link.

2. The non-AP MLD of claim 1, wherein:
the indication is an indication to suspend or resume an individual TWT agreement that is established on the second link, and
the TWT SPs correspond to the individual TWT agreement.

3. The non-AP MLD of claim 1, wherein:
the indication is an indication to suspend or resume a broadcast TWT schedule that is established on the second link, and
the TWT SPs correspond to the broadcast TWT schedule.

4. The non-AP MLD of claim 1, wherein:
the TWT Information frame, in conjunction with another frame, includes TWT information and a link identifier (ID) for the second link that indicates that the TWT information is intended for the second link, and
the TWT information indicates to suspend or resume the TWT SPs.

5. The non-AP MLD of claim 1, wherein:
the TWT Information frame, in conjunction with another frame, includes TWT information sets respectively intended for one or more links and a link ID bitmap that indicates the one or more links including the second link, and
each TWT information set indicates to suspend or resume the TWT SPs on the respective link.

6. The non-AP MLD of claim 5, wherein:
each TWT information set includes at least one Broadcast TWT ID or TWT Flow ID,
the Broadcast TWT ID identifies a broadcast TWT schedule established on the respective link, and
the TWT Flow ID identifies an individual TWT agreement established on the respective link.

7. The non-AP MLD of claim 5, wherein TWT SPs are not suspended or resumed on links that are not indicated in the link ID bitmap.

8. An access point (AP) multi-link device (MLD), comprising:
APs comprising transceivers configured to form links with stations (STAs), respectively, the STAs affiliated with a non-AP MLD; and
a processor operably coupled to the transceivers,
wherein a first of the transceivers is further configured to transmit to or receive from the non-AP MLD over a first of the links a multi-link operation (MLO)-supporting target wake time (TWT) Information frame that includes an indication to suspend or resume TWT service periods (SPs) on a second of the links, and
wherein the processor is configured to, based on the TWT Information frame being transmitted or received successfully over the first link, suspend or resume the TWT SPs on the second link.

9. The AP MLD of claim 8, wherein:
the indication is an indication to suspend or resume an individual TWT agreement that is established on the second link, and
the TWT SPs correspond to the individual TWT agreement.

10. The AP MLD of claim 8, wherein:
the indication is an indication to suspend or resume a broadcast TWT schedule that is established on the second link, and
the TWT SPs correspond to the broadcast TWT schedule.

11. The AP MLD of claim 8, wherein:
the TWT Information frame, in conjunction with another frame, includes TWT information and a link identifier (ID) for the second link that indicates that the TWT information is intended for the second link, and
the TWT information indicates to suspend or resume the TWT SPs.

12. The AP MLD of claim 8, wherein:
the TWT Information frame, in conjunction with another frame, includes TWT information sets respectively intended for one or more links and a link ID bitmap that indicates the one or more links including the second link, and
each TWT information set indicates to suspend or resume the TWT SPs on the respective link.

13. The AP MLD of claim 12, wherein:
each TWT information set includes at least one Broadcast TWT ID or TWT Flow ID,
the Broadcast TWT ID identifies a broadcast TWT schedule established on the respective link, and
the TWT Flow ID identifies an individual TWT agreement established on the respective link.

14. The AP MLD of claim 12, wherein TWT SPs are not suspended or resumed on links that are not indicated in the link ID bitmap.

15. A method of wireless communication performed by a non-access point (AP) multi-link device (MLD) that comprises stations (STAs), the method comprising:
transmitting to or receiving from an AP MLD, over a first one of links formed between the STAs and APs affiliated with the AP MLD, a multi-link operation (MLO)-supporting target wake time (TWT) Information frame that includes an indication to suspend or resume TWT service periods (SPs) on a second of the links; and
based on the TWT Information frame being transmitted or received successfully over the first link, suspending or resuming the TWT SPs on the second link.

16. The method of claim 15, wherein:
the indication is an indication to suspend or resume an individual TWT agreement that is established on the second link, and
the TWT SPs correspond to the individual TWT agreement.

17. The method of claim 15, wherein:
the indication is an indication to suspend or resume a broadcast TWT schedule that is established on the second link, and
the TWT SPs correspond to the broadcast TWT schedule.

18. The method of claim 15, wherein:
the TWT Information frame, in conjunction with another frame, includes TWT information and a link identifier (ID) for the second link that indicates that the TWT information is intended for the second link, and
the TWT information indicates to suspend or resume the TWT SPs.

19. The method of claim 15, wherein:
the TWT Information frame, in conjunction with another frame, includes TWT information sets respectively intended for one or more links and a link ID bitmap that indicates the one or more links including the second link, and
each TWT information set indicates to suspend or resume the TWT SPs on the respective link.

20. The method of claim 15, wherein:
each TWT information set includes at least one Broadcast TWT ID or TWT Flow ID,
the Broadcast TWT ID identifies a broadcast TWT schedule established on the respective link, and
the TWT Flow ID identifies an individual TWT agreement established on the respective link.
